(19) United States
(12) Patent Application Publication
(10) Pub. No.: US 2011/0050898 A1
(43) Pub. Date: Mar. 3, 2011

(54) VIDEO MONITORING SYSTEM AND VIDEO MONITORING METHOD

(75) Inventors: YANG-YUAN CHEN, Tu-Cheng (TW); MING-CHIH HSIEH, Tu-Cheng (TW)

(73) Assignee: HON HAI PRECISION INDUSTRY CO., LTD., Tu-Cheng (TW)

(21) Appl. No.: 12/629,887

(22) Filed: Dec. 3, 2009

(30) Foreign Application Priority Data
Aug. 26, 2009 (CN) 200910306140.0

(51) Int. Cl. H04N 7/18

(52) U.S. Cl. 348/143; 348/E07.085

(57) ABSTRACT

A video monitoring system and a video monitoring method are provided. The video monitoring system includes at least one video camera, and a computer connected with the at least one video camera via a universal serial bus (USB) line. The at least one video camera obtains video streams, converts the video streams into USB-compatible signals, and transmits the USB-compatible signals to the computer via the USB line. The USB-compatible signals may be displayed on the computer as video images and synchronously played on a speaker of the computer as the audio.

### BACKGROUND

1. Technical Field

Embodiments of the present disclosure generally relate to video monitoring devices and monitoring methods, and more particularly to a video monitoring system and a video monitoring method thereof.

2. Description of Related Art

Network cameras are typically employed for monitoring an activity in one location. Using a dedicated network video recorder or video management software in a personal computer (PC), video data from all the cameras are recorded simultaneously. For example, each of the network cameras captures the video data, and transmits the video data to the PC via a large frequency band. Before displaying video images on a display screen of the PC, parameters of the PC may be set to decode the video data. That is, the network cameras do not have decoding functions to decode the video data, and the video data are transmitted through large frequency bands.

What is needed, therefore, is an improved video monitoring device and a video monitoring method, so as to overcome the above-mentioned problems.

### BRIEF DESCRIPTION OF THE DRAWINGS

FIG. 1 is a schematic diagram of one embodiment of a video monitoring system.

FIG. 2 is a schematic diagram of one embodiment of a video monitoring system with a connecting hub.

FIG. 3 is a block diagram of one embodiment of a video camera of FIG. 1.

FIG. 4 is a flowchart illustrating one embodiment of a method for monitoring an area by using the video monitoring system of FIG. 1 or FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

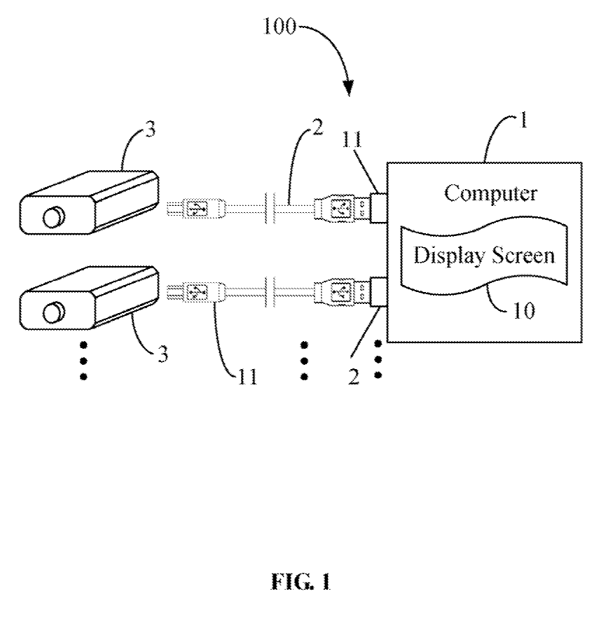

FIG. 1 is a schematic diagram of one embodiment of a video monitoring system 100. The video monitoring system 100 typically includes a computer 1, and at least one video camera 3. The computer 1 includes one or more universal serial bus (USB) ports 11. Each of the one or more USB ports 11 can be connected with a USB line 2. The computer 1 connects with each of the at least one video camera 3 via the USB line 2. In the embodiment, the at least one video camera 3 is installed in an area to be monitored. The at least one video camera 3 is operable to obtain a plurality of video streams of the monitored area, convert the video streams into signals which can be transmitted by the USB line 2 and is compatible with the USB ports 11 (hereinafter referred as “USB-compatible signals”). The USB-compatible signals are transmitted to the USB ports 11. The computer 1 is operable to generate video images according to the USB-compatible signals, and display the video images on a display screen 10. Thus, a user can browse the video images displayed on the display screen 10 to determine whether the monitored area has abnormities.

In one embodiment, each of the at least one video camera 3 has an identification (ID). The computer 1 can identify the video streams captured by different video cameras 3 according to the ID. In the embodiment, each video camera 3 may be a network camera, for example.

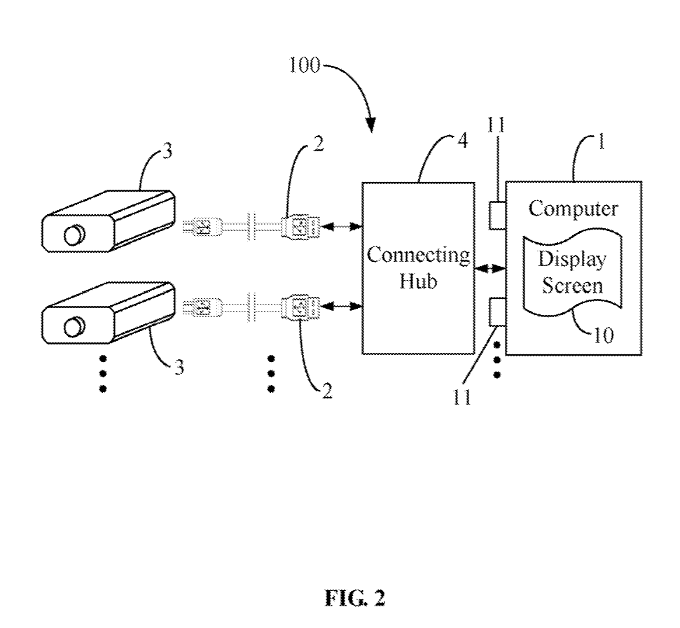

Referring to FIG. 2, a connecting hub 4 needs to be arranged between the USB line 2 and the computer 1 for extending USB ports 11 of the computer 1, if there are more video cameras 3 installed in the monitored area than there are USB ports 11, namely, a total number of the video cameras 3 is larger than a total number of the USB ports 11.

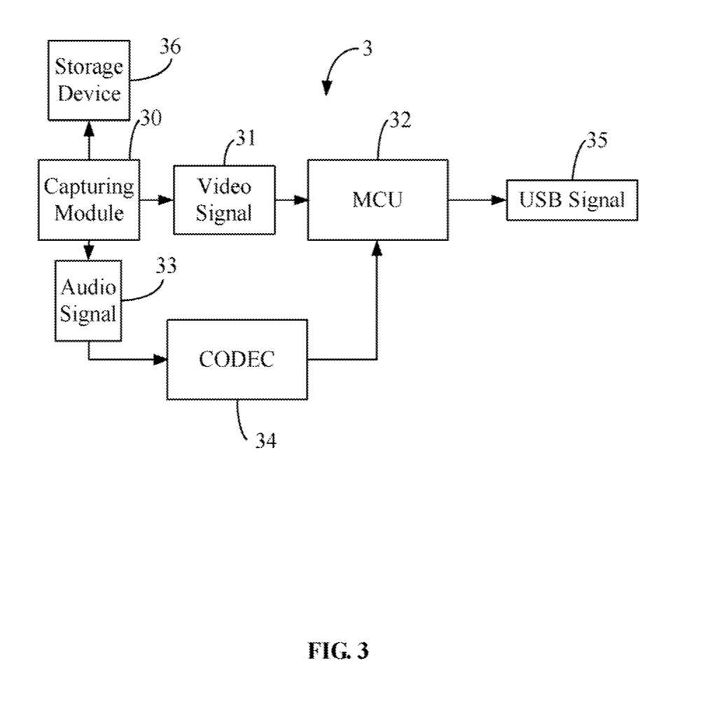

FIG. 3 is a block diagram of one embodiment of an example illustrating one of the video cameras 3. In the embodiment, the video camera 3 may include a capturing module 30, a CODEC 34, a micro-programmed control unit (MCU) 32, and a storage device 36. One or more computerized codes of the capturing module 30 may be stored in the storage device 36 and executed by the MCU 32. In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

The capturing module 30 is operable to obtain a plurality of video streams of the monitor area, separate each of the video streams to audio data and video data, and then send the audio data to the CODEC 34. The CODEC 34 is operable to decode the audio data.

The capturing module 30 is further operable to send the video data to the MCU 32. The MCU 32 is operable to receive the decoded audio data from the CODEC 34, and receive the video data from the capturing module 30. The MCU 32 is further operable to convert the decoded audio data and the video data into USB-compatible signals, and transmit the USB-compatible signals to the computer 1.

The computer 1 receives the USB-compatible signals via a corresponding USB port 11, generates video images with sound according to the USB-compatible signals, displays the video images on the display screen 10, and synchronously plays the audio using a speaker of the computer 1.

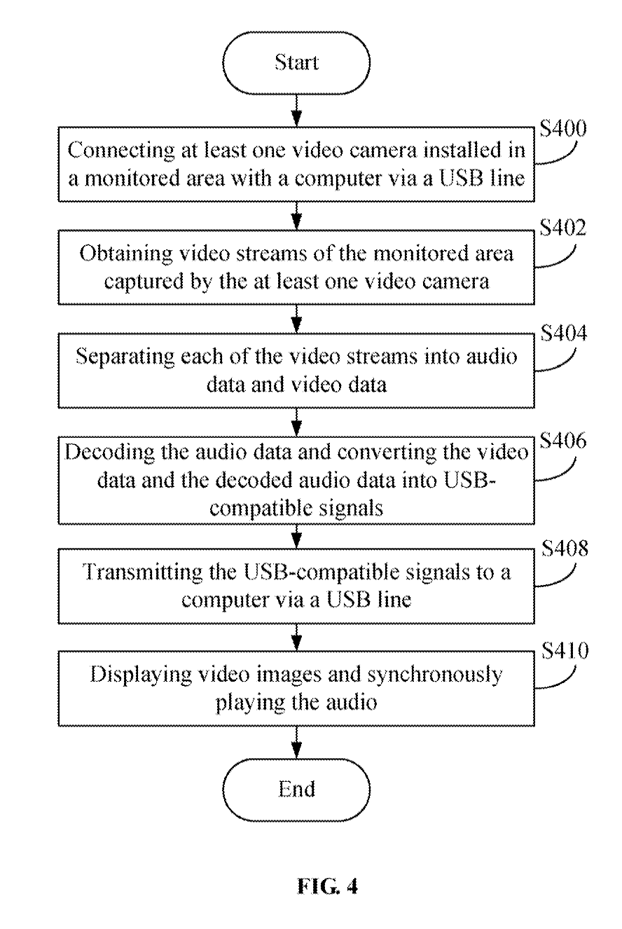

FIG. 4 is a flowchart illustrating one embodiment of a method for monitoring an area by using the video monitoring system 100.

In block S400, a user connects the at least one video camera 3 installed in a monitored area with the computer 1 via the USB line 2 to the computer 1.

In block S402, the capturing module 30 obtains video streams of the monitored area captured by the at least one video camera 3.

In block S404, the capturing module 30 separates each of the video streams to audio data and video data, sends the audio data to the CODEC 34, and sends the video data to the MCU 32.

In block S406, the CODEC 34 decodes the audio data, the MCU 32 converts the decoded audio data and the video data into USB-compatible signals.

In block S408, the MCU 32 transmits the USB-compatible signals to the computer 1 via the USB line 2.

In block S410, the computer 1 generates video images with sound according to the USB-compatible signals, and displays the video images on the display screen 10 and synchronously plays the audio using a speaker of the computer 1.

If the connecting hub 4 is arranged between the computer 1 and the USB line 2, in block S408, the MCU 32 may transmit the USB-compatible signals to the computer 1 via the connecting hub 4.

All of the processes described above may be embodied in, and fully automated via, functional code modules executed by one or more general purpose processors of computing devices. The functional code modules may be stored in any type of readable medium or other storage devices. Some or all of the methods may alternatively be embodied in specialized the computing devices.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A video monitoring method using at least one video camera, the video monitoring method comprising:
connecting the at least one video camera with a computer via a universal serial bus (USB) line;
obtaining video streams captured by the at least one video camera;
separating each of the video streams into audio data and video data;
decoding the audio data by using a CODEC of the at least one video camera;
converting the video data and the decoded audio data into USB-compatible signals;
transmitting the USB-compatible signals to the computer via the USB line; and
displaying the USB-compatible signals as video images on a display screen of the computer and synchronously playing the audio using a speaker of the computer.

2. The video monitoring method as described in claim 1, wherein each of the at least one video camera comprises an identification (ID) that is used to identify the video streams captured by the video camera.

3. The video monitoring method as described in claim 1, wherein each of the at least one video camera is a network camera.

4. The video monitoring method as described in claim 1, wherein the computer is connected with a connecting hub for extending USB ports.

5. The video monitoring method as described in claim 4, wherein the transmitting block comprising:
transmitting the USB-compatible signals to the connecting hub via the USB line; and
transmitting the USB-compatible signals from the connecting hub to the computer.

6. A video monitoring system, comprising:
at least one video camera; and
at least one universal serial bus (USB) line;
the at least one video camera connecting a computer via the at least one USB line, each of the at least one video camera comprising:
a capturing module operable to obtain video streams, and separate the video streams into video data and audio data;
a CODEC operable to decode the audio data; and
a micro-programmed control unit (MCU) operable to convert the decoded audio data and the video data into USB-compatible signals, and transmit the USB-compatible signals to the computer through the USB line; and
the computer configured for generating video images with according to the USB-compatible signals, displaying the video images on a display screen, and synchronously playing the audio.

7. The video monitoring system as described in claim 6, wherein each of the at least one video camera comprises an identification (ID) that is used to identify the video streams captured by the video camera.

8. The video monitoring system as described in claim 6, further comprising:
a connecting hub arranged between the USB line and the computer to extend USB ports of the computer if a total number of the video cameras is larger than a total number of the USB ports.

9. The video monitoring system as described in claim 6, wherein each video camera is a network camera.

10. A video monitoring system, comprising:
at least one video camera, each of the at least one video camera comprising:
a capturing module operable to obtain video streams, and separate each of the video streams into video data and audio data;
a CODEC operable to decode the audio data; and
a micro-programmed control unit (MCU) operable to convert the decoded audio data and the video data into USB-compatible signals, and transmit the USB-compatible signals to a computer.

11. The video monitoring system as described in claim 10, wherein each of the at least one video camera comprises an identification (ID) that is used to identify the video streams captured by the video camera.

12. The video monitoring system as described in claim 10, further comprising:
at least one universal serial bus (USB) line configured for connecting the at least one video camera with the computer.

13. The video monitoring system as described in claim 12, further comprising:
a connecting hub arranged between the USB line and the computer to extend USB ports of the computer if a total number of the video cameras is larger than a total number of the USB ports.

14. The video monitoring system as described in claim 10, wherein the at least one video camera is a network camera.
